(19) United States
(12) Patent Application Publication
(10) Pub. No.: US 2005/0053740 A1
(43) Pub. Date: Mar. 10, 2005

(54) Bendable tubular elongated toy

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Melvin L. Crane, 318 S. Cleveland Street, Arlington, VA, 22204-2038, US

(21) Appl. No.: 10/656,689

(22) Filed: Sep. 8, 2003

(51) Int. Cl. B32B 1/08

(52) U.S. Cl. 428/36.9

(57) ABSTRACT

A bendable tube which can be bent into any desired shape which is retained in the bent shape for pleasure as a toy. The tube can be filled with a delectable food product which is retained by a stopper on opposite ends of the tube.

### BACKGROUND OF THE INVENTION

This invention is directed to a bendable, tubular, longated toy which can be shaped into different shapes for enjoyment of a delectable substance therein. The bendable, tubular, elongated toy can contain candy granules, powder, liquid or any other desired delectable foodstuff which can be removed from the tubular toy by squeezing the tubular toy or by suction by the person who desires to remove the foodstuff.

### PRIOR ART

Heretofore candy-type toys have been made using tubular straws through which a liquid-type drink can be withdrawn, such as shown in U.S. Pat. No. 3,545,980. A candy piece is secured on one end of the straw so that a solution withdrawn through the straw can mix with a portion of the candy piece as the liquid is withdrawn and the candy piece is liquified to mix with the candy.

Another type of tubular dispenser has been set forth in U.S. Pat. No. 4,798,313 through which a frozen confection can be dispensed as the frozen confection begins to melt and can be removed from the tube by suction or by contraction of the tubular container.

Still another bendable toy holder for a candy lollipop has been set forth in U.S. Pat. No. 5,938,153. However, there is no teaching that a delectable foodstuff be contained in the tubular parts from which the foodstuff can be withdrawn.

### BRIEF SUMMARY OF THE INVENTION

An object of the invention is to provide a novel toy which has an elongated tubular body which can be bent or twisted into different shapes such as similar to an eyeglass frame including temples, or to any tubular configuration in which a delectable foodstuff can be held for consumption by a person.

Another object is to provide a tubular elongated body which contains a delectable foodstuff such as candy granules, powdered confection, or a chewy type of a delectable foodstuff including a pastry or a liquid. In order to fix the foodstuff in the elongated tubular body, each end of the tubular body is closed by any convenient reusable cap.

Other objects and benefits of the invention will be obvious to those skilled in the art upon reading the specification and viewing the drawings.

### BRIEF DESCRIPTION OF THE DRAWINGS

FIG. 1 illustrates a one-piece elongated tubular housing which has been bent to simulate a pair of glasses.

FIG. 2 illustrates a pair of glasses, as shown in FIG. 1, including a delectable food product therein.

### DETAILED DESCRIPTION OF THE DRAWINGS

The drawings illustrate the use of a one-piece elongated tubular housing 10 bent to be configured as a pair of glasses including temples 12 and 14, lens holders 16 and 18 and a bridge 20. As clearly seen in the drawings, temple 12 is formed and then the tube is bent into a circular lens holder 16 with an end of the tube directed to lens holder 18 by which a bridge 20 is formed. The circular lens holder 18 is formed and then the remaining end of the tube 10 forms the temple 14.

It would be obvious to one skilled in the art that instead of simulating eyeglasses, bracelets and other jewelry can be formed. The delectable food product 22 can be added to the tube before the tube is bent to different shapes or can be added to the tube after it has been bent into a desired shape. Of course, end caps 24, 26 are placed onto the ends of the tubular elongated housing to prevent th delectable food product from spilling from the tube.

Since the tube has two end stops 24 and 26, one on each end, the food product can be dispensed from either end. Once the delectable food product 22 has been totally dispensed from the tube, the tube can be used as an ornament or a new food product can be added for further dispensing. If all of the delectable food product has not been dispensed, the end stops can be replaced onto the ends of the tube to prevent the delectable food product from being dispensed from the tube when it is not wanted.

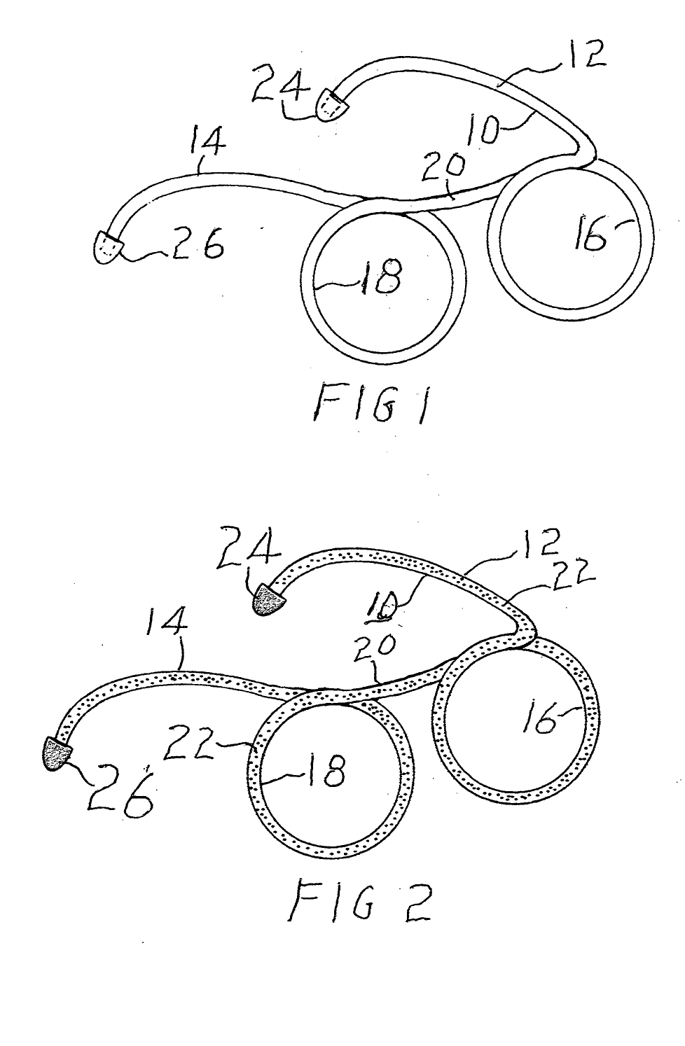

The tube in which the delectable food product is stored is of a type which can be bent or formed into different designs including straight, curved, or circular configurations in which the tube remains in the shape to which the tube has been formed. FIG. 1 illustrates an elongated tube which has been formed into a shape of a pair of glasses. Since the glasses formed represent a pair of glasses without the lenses, the particular shape of the temples, the configuration of the lens holders, etc. do not have to be exact as in a real pair of glasses. The tube may be formed by a plastic which when bent will retain the bent shape as formed. Thus, such a tube could be formed into any shape to represent an enjoyable play toy for a person.

FIG. 2 illustrates a pair of glasses such as shown in FIG. 1, which includes a granular type of candy, gum, or any other amusing product which can be dispensed by removal of one of the end strops.

The foregoing relates to preferred exemplary embodiments of the invention, it being understood that other variants and embodiments thereof are possible within the spirit and scope of the invention, the latter being defined by the appended claims.

1. A bendable tube of any desirable length which is formed of a material which can be bent or twisted into a desired shape, in which the tube retains its bent or twisted shape to provide an enjoyable toy.

2. A bendable tube as set forth in claim 1, in which
said tube is formed as a frame for a pair of eyeglasses, a piece of jewelry, or any other use.

3. A bendable tube as set forth in claim 1, which includes
a stopper on opposite ends of said tube.

4. A bendable tube as set forth in claim 2, which includes
a stopper on opposite ends of said tube.

5. A bendable tube as set forth in claim 2, in which
said bendable tube incudes a substance therein for use upon being dispensed from said tube.

6. A bendable tube as set forth in claim 3, in which
said bendable tube includes a substance therein for use upon being dispensed from said tube.

7. A bendable tube as set forth in claim 5, in which
said substance includes one of the following: a delectable powder, a candy product, a solution, a delectable food product, or any product which can be filled into and dispensed from said tube.

8. A bendable tube as set forth in claim 6, in which
said substance includes one of the following: a delectable powder, a candy product, a solution, a delectable food product, or any product which can be filled into and dispensed from said tube.
